(19) United States
(12) Patent Application Publication
(10) Pub. No.: US 2025/0209418 A1
(43) Pub. Date: Jun. 26, 2025

(54) SYSTEM AND METHODS FOR PHYSICAL IDENTIFICATION OF MANUFACTURED PRODUCTS

(71) Applicant: Microchip Technology Incorporated, Chandler, AZ (US)

(72) Inventors: Roger Winkles, Gilbert, AZ (US); Manuschai Chainok, Chachoengsao (TH)

(73) Assignee: Microchip Technology Incorporated, Chandler, AZ (US)

(21) Appl. No.: 18/613,346

(22) Filed: Mar. 22, 2024

Related U.S. Application Data
(60) Provisional application No. 63/613,842, filed on Dec. 22, 2023.

(51) Int. Cl. G06Q 10/087

(52) U.S. Cl. CPC G06Q 10/087

(57) ABSTRACT

A manufactured product may include a machine-readable physical identifier and the machine-readable physical identifier may be stored in a tracking file. The machine-readable physical identifier may be encoded with manufacturing information related to the manufactured product, including but not limited to manufacturing location, lot number and manufacturing date. The tracking file may be updated based on one or more supply chain operations, including but not limited to a testing operation, a shipping operation or a delivery operation. The tracking file may include information on testing results, shipping origin and destinations and delivery locations. The tracking file may be delivered to a customer along with the manufactured products listed in the tracking file.

### PRIORITY

This application claims priority to commonly owned U.S. Patent Application No. 63/613,842 filed Dec. 21, 2023, the entire contents of which are hereby incorporated by reference for all purposes.

### FIELD OF THE INVENTION

The present disclosure relates to a system and method for physical identification for manufactured products and tracking of information related to the manufactured products.

### BACKGROUND

Tracking manufactured products from a manufacturing location to an end customer can be a complicated problem for manufacturers. Additionally, tracing products which may fail at a customer location and discovering issues in manufacturing operations may be a difficult and time-consuming process.

In semiconductor products, individual products may be marked based on an alphanumeric code, or identifier, written onto the surface of the product. However, such markings may not include information specific to individual products, also called units.

Existing solutions may include an identifier which includes a combination of numerical values and alpha-numeric symbols to indicate information including but not limited to manufacturing date, manufacturing location and product number.

Existing solutions may not utilize machine readable identifiers and may require manual work to decipher further information from the identifier. Information contained in the identifier may not be associated with any information after manufacturing, including testing results, shipping information and delivery information. Additionally, existing machine-readable physical identifiers may not include error-correction in cases where the identifier may be damaged. An error-correcting code may enable a machine-readable physical identifier to be read by a scanner, camera or other imaging device even if the physical identifier has been damaged.

There is a need for a machine-readable physical identifier which may be associated with individual manufactured products and may be linked to a file including information on the manufacturing, testing, shipping and delivery of the manufactured products.

### SUMMARY

The examples herein enable a system for tracking information related to a manufactured product based on a machine-readable physical identifier and a tracking file.

According to one aspect, a system includes a manufactured product comprising a machine-readable physical identifier, the machine-readable physical identifier to encode one or more data elements related to the manufactured product. The system includes a tracking file wherein the one or more data elements are matched to the manufactured product, the tracking file to be updated based on one or more supply chain operations.

According to one aspect, a method includes steps of: affixing a machine-readable physical identifier to a manufactured product, reading the physical identifier, processing the manufactured product as part of a manufacturing, testing or supply chain operation, updating a tracking file based on the results of the manufacturing, testing or supply chain operation, sorting the manufactured product based on the results of the manufacturing, testing or supply chain operation, sending the manufactured product and the tracking file to a customer.

### BRIEF DESCRIPTION OF THE DRAWINGS

FIG. 1 illustrates one of various examples of a semiconductor product with a machine-readable physical identifier.

FIG. 2 illustrates a system for tracking information related to a manufactured product.

FIG. 3 illustrates one of various examples of a machine-readable physical identifier.

FIG. 4 illustrates another example of a machine-readable physical identifier.

FIG. 5 illustrates one of various examples of a tape-and-reel segment including semiconductor products with machine-readable physical identifiers.

FIG. 6 illustrates a method of attaching a machine-readable physical identifier and tracking information related to manufactured products.

### DETAILED DESCRIPTION

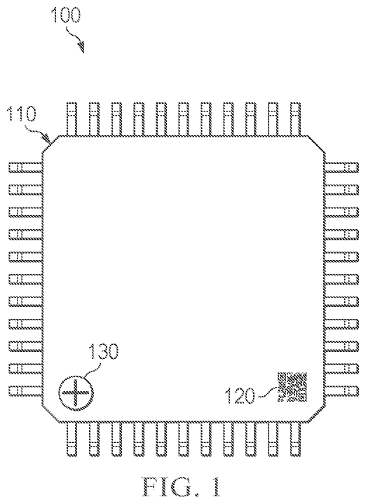

FIG. 1 illustrates one of various examples of a semiconductor product 100 with a machine-readable physical identifier. A physical identifier may comprise a sequence of alphanumeric characters, a barcode, or an encoded identifier including but not limited to a Data Matrix code or a Quick Response (QR) code. Semiconductor product 100 may include semiconductor package 110. Semiconductor package 110 may be a ceramic package, a plastic package or another material and may contain one or more semiconductor dice. Semiconductor package 110 may include leads as shown in FIG. 1 and may include solder balls on the underside of the package (not shown). The example illustrated in FIG. 1 relates to a semiconductor product, but this is not intended to be limiting. A machine-readable physical identifier may be included on any manufactured product.

Semiconductor package 110 may include pin one marker 130. Pin one marker 130 may indicate the location of pin 1 on semiconductor package 110. Pin one marker 130 may be in the lower left of semiconductor package 110 as illustrated in FIG. 1 but this is not intended to be limiting. Pin one marker 130 may be in another location.

Semiconductor package 110 may include machine-readable physical identifier 120. Machine-readable physical identifier 120 may be a Data Matrix code, a Quick-Response (QR) code, or another form of machine-readable physical identifier. Machine-readable physical identifier 120 may be encoded with one or more data elements related to the manufacturing and packaging of the semiconductor product, including but not limited to manufacturing year, manufacturing week, manufacturing day, manufacturing location, manufacturing lot, location on the wafer, tape-and-reel strip number, row location and column location within a tape-and-reel strip. Machine-readable physical identifier 120 may be encoded using an error-correcting code, including but not limited to ECC-200.

Machine-readable physical identifier 120 may be located in the lower right of semiconductor package 110 as illustrated in FIG. 1 or may be in another location on the surface of semiconductor die 110.

Machine-readable physical identifier 120 may be affixed to semiconductor package 110 by printing directly on semiconductor package 120, by adhesion of a label onto semiconductor package 110, by laser marking or engraving, etching, or by another method not specifically mentioned.

Machine-readable physical identifier 120 may be read by an optical scanner, a camera or another type of reader.

An associated tracking file may include additional information associated with each machine-readable physical identifier. The tracking file may include one or more data elements related to one or more supply chain operations, the supply chain operations including but not limited to testing, optical analysis and shipping.

For a given semiconductor product, respective semiconductor packages may each include respective physical identifiers.

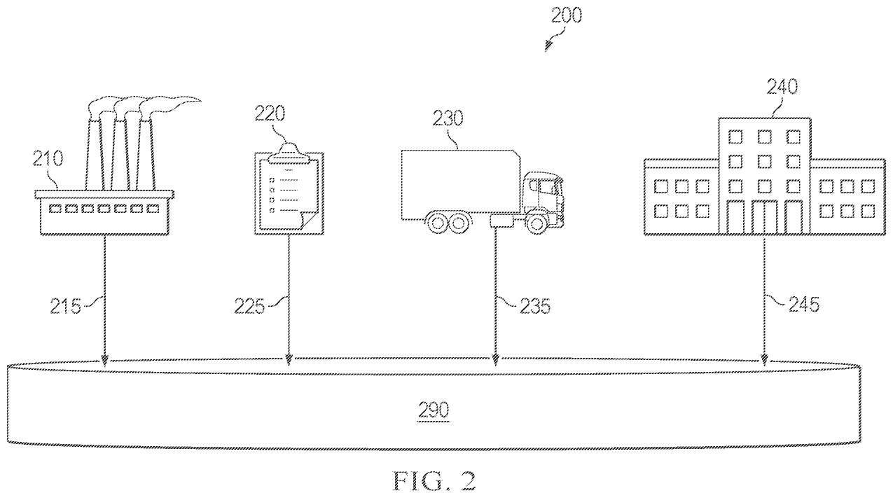

FIG. 2 illustrates a system 200 for tracking information related to a manufactured product.

The images of different steps in the manufacturing process are for illustrative purposes only and are not intended to be limiting. Manufacturing steps may be performed using processes different from those illustrated in FIG. 2.

A product may be manufactured at a manufacturing plant 210. As part of the manufacturing of the product, a machine-readable physical identifier may be affixed to the product. The machine-readable physical identifier may be affixed to the product by printing directly on the product, by adhesion of a label onto the product, by laser marking or engraving, etching, or by another method not specifically mentioned.

Manufacturing information 215 of respective products may be stored into tracking file 290. The machine-readable physical identifier of respective products may be recorded in tracking file 290. Manufacturing information 215 may be associated with the machine-readable physical identifier of respective products. As one of various examples, a first row of tracking file 290 may be associated with a first unit and may include the machine-readable physical identifier of the first unit. The first row of tracking file 290 may include manufacturing information 215 associated with the first unit. A second row of tracking file 290 may be associated with a second unit and may include the machine-readable physical identifier of the second unit. The second row of tracking file 290 may include manufacturing information 215 of a second unit.

Manufacturing information 215 stored in tracking file 290 for respective products may include manufacturing date, manufacturing location, lot number, production line, and other manufacturing information not specifically mentioned. Manufacturing information 215 may include packaging information including but not limited to tape-and-reel row and column location, packaging location, and packaging date.

At operation 220, the product may be tested. Testing may include one or more automated testing programs which may produce pass/fail results, parametric results and other numerical and qualitative results. Testing results 225 of the testing operation may be stored in tracking file 290. In the current example, testing results 225 of a first unit may be appended to the first row of tracking file 290 and may be associated with the machine-readable physical identifier affixed to the first unit. Testing results 225 of the second unit may be appended to the second row of tracking file 290 and may be associated with the machine-readable physical identifier affixed to the second product. In this manner, tracking file 290 may include manufacturing information 215 and testing results 225 for respective products. As part of the testing, the machine-readable physical identifier may be read by a scanner, camera or other optical sensing apparatus.

The manufactured products may be sorted based on information in the tracking file. As one of various examples, manufactured products exceeding a performance threshold during testing may be sorted into a passing group and those not exceeding the performance threshold may be sorted into a failing group.

At operation 230, the product may be transported or shipped. FIG. 2 illustrates shipment via a truck, but this is not intended to be limiting. Shipping information 235 for respective products may be stored in tracking file 290. Shipping information 235 may include shipping origin, shipping destination, vehicle, container or other shipping information not specifically mentioned. In the current example, shipping information 235 of a first unit may be appended to the first row of tracking file 290 and may be associated with the machine-readable physical identifier affixed to the first unit. Shipping information 235 of a second unit may be appended to the second row of tracking file 290 and may be associated with the machine-readable physical identifier affixed to the second product. In this manner, tracking file 290 may include manufacturing information 215, testing results 225, and shipping information 235 for respective manufactured products. As part of the transportation and shipping, the machine-readable physical identifier may be read by a scanner, camera or other optical sensing apparatus.

At operation 240, the product may be delivered to a customer facility. Delivery information 245 for respective products may be stored in tracking file 290. Delivery information 245 may include delivery location, delivery date and time, signature or other authorization information and other delivery information not specifically mentioned. In the current example, delivery information 245 of the first unit may be appended to the first row of tracking file 290 and may be associated with the first unit based on the machine-readable physical identifier affixed to the first unit. Delivery information 235 of the second unit may be appended to the second row of tracking file 290 and may be associated with the machine-readable physical identifier affixed to the second product. As part of the delivery, the machine-readable physical identifier may be read by a scanner, camera or other optical sensing apparatus. In this manner, tracking file 290 may include manufacturing information 215, testing results 225, shipping information 235 and delivery information 245 for respective products.

A machine-readable physical identifier may be affixed to products on a unit-by-unit basis, such that individual products may be tracked based on their respective machine-readable physical identifier.

The example of FIG. 2 illustrates a specific sequence of supply chain operations, namely manufacturing, then testing, then shipping and then delivery. This sequence is not intended to be limiting. Other examples may perform supply chain operations in a different order than those performed in the example of FIG. 2. Other examples may include supply chain operations not specifically mentioned in reference to FIG. 2 or may omit supply chain operations specifically mentioned in reference to FIG. 2.

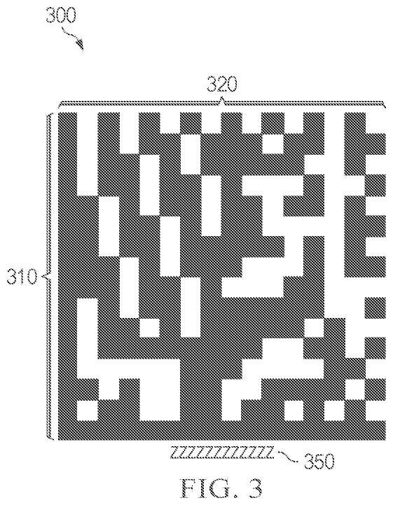

FIG. 3 illustrates one of various examples of a machine-readable physical identifier 300. Machine-readable physical identifier 300 may comprise a 16×16 Data Matrix cell. Machine-readable physical identifier 300 may include 16 rows 310 and 16 columns 320. Machine-readable physical identifier 300 may encode 12 alphanumeric characters, as indicated by codeword 350. Codeword 350 is illustrated as ‘ZZZZZZZZZZZZ’ in FIG. 3, but this is merely to demonstrate that codeword 350 comprises 12 alphanumeric characters. The contents of codeword 350 may be any combination of 12 alphanumeric characters and is not limited to alphanumeric character ‘Z’.

Machine-readable physical identifier 300 may encode manufacturing information including but not limited to manufacturing year, manufacturing week, manufacturing day, lot number, manufacturing facility, and product number. The product number may be a generic number for all units of a particular type or may be a specific number associated with one or more units. Machine-readable physical identifier 300 may encode packaging information including but not limited to row and column information in a tape-and-reel package, and row and column information in a tray of products. The encoding of machine-readable physical identifier 300 may include an error-correcting code.

The example of FIG. 3 illustrates a machine-readable physical identifier 300 of a 16×16 dimension, but this is not intended to be limiting. Other examples of a machine-readable physical identifier may be larger than machine-readable physical identifier 300 or smaller than machine-readable physical identifier 300.

In the example of FIG. 3, machine-readable physical identifier 300 is illustrated as a Data Matrix cell, but this is not intended to be limiting. Machine-readable physical identifier 300 may be a QR code or another machine-readable code.

In operation, a tracking file may record respective machine-readable physical identifiers 300 with respective units, and may record manufacturing, testing, shipping and delivery information associated with respective units.

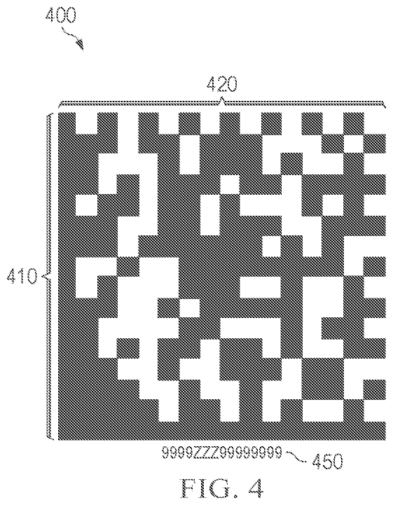

FIG. 4 illustrates another example of machine-readable physical identifier 400. Machine-readable physical identifier 400 may comprise a 16×16 Data Matrix cell. Machine-readable physical identifier 400 may include 16 rows 410 and 16 columns 420. Machine-readable physical identifier 400 may encode 12 numeric characters and 3 alphanumeric characters, as indicated by codeword 450. Codeword 450 is illustrated as ‘9999ZZZ99999999’, but this is merely to demonstrate that codeword 450 comprises 12 numeric characters and 3 alphanumeric characters. The contents of codeword 450 may be any combination of 3 numeric characters. The contents of codeword 450 may be any combination of 12 alphanumeric characters and is not limited to alphanumeric character ‘Z’.

As one of various examples, codeword 450 may be encoded as alphanumeric sequence ‘1234ABC01432311’. Alphanumeric sequence “1234” may indicate the product is part number 1234, where the part number is a unique identifier for a specific catalog product. As one of various examples, the part number may indicate a 5-V boost converter, or a 16-bit 4-channel analog-to-digital converter. Alphanumeric sequence “ABC” may indicate the product was manufactured on manufacturing line A, in building B at facility C. Alphanumeric sequence “0143” may indicate the product was manufactured on the first day of the 43^{rd} week. Alphanumeric sequence “2311” may indicate the product is located in the 23^{rd} position in the 11^{th} tape-and-reel package. Alphanumeric sequence “1234ABC01432311” may thus identify the particular unit from among a plurality of units produced. Alphanumeric sequence “1234ABC01432311” may be encoded as a Data Matrix code to generate machine-readable physical identifier 400. Alphanumeric sequence “1234ABC01432311” may be encoded as a QR code to generate machine-readable physical identifier 400. The encoding of machine-readable physical identifier 400 may include an error-correcting code.

Machine-readable physical identifier 400 may encode manufacturing information including but not limited to manufacturing year, manufacturing week, manufacturing day, lot number, manufacturing facility, and product number. Machine-readable physical identifier 400 may encode packaging information including but not limited to row and column information in a tape-and-reel package, and row and column information in a tray of products.

The example of FIG. 4 illustrates a specific combination of 12 numeric characters and 3 alphanumeric characters, specifically 4 numeric characters followed by 3 alphanumeric characters followed by 8 numeric characters, but this is not intended to be limiting.

The example of FIG. 4 illustrates a machine-readable physical identifier 400 of a 16×16 dimension, but this is not intended to be limiting. Other examples of a machine-readable physical identifier may be larger than machine-readable physical identifier 400 or smaller than machine-readable physical identifier 400.

In operation, a tracking file may record respective machine-readable physical identifiers 400 with respective units, and may record manufacturing, testing, shipping and delivery information associated with respective units.

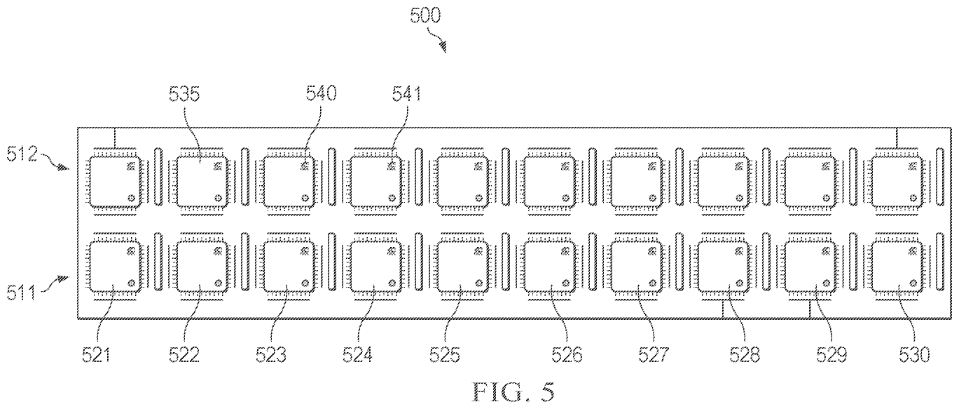

FIG. 5 illustrates one of various examples of a tape-and-reel segment 500 including semiconductor products with machine-readable physical identifiers. Segment 500 may be one portion of a larger tape-and-reel package.

Segment 500 may include a first row 511 and a second row 512. Other examples may include a single row or may include more than two rows. Segment 500 may include columns 521, 522, 523, 524, 525, 526, 527, 528, 529 and 530. Individual semiconductor packages may be indexed by their row and column. As one example, package 535 may be indexed as second row 512 and second column 522.

Individual semiconductor packages may include a machine-readable physical identifier. As one of various examples, the semiconductor package at the second row 512 and fourth column 524 may include machine-readable physical identifier 541. Machine-readable physical identifier 541 may be encoded with one or more data elements related to the manufacturing of the semiconductor product, including but not limited to manufacturing year, manufacturing week, manufacturing day, manufacturing location, manufacturing lot, tape-and-reel strip, tape-and-reel row location and tape-and-reel column location. Machine-readable physical identifier 541 may be encoded using an error-correcting code, including but not limited to ECC-200.

A tracking file may record machine-readable physical identifier 540 and may associate machine-readable physical identifier 540 with the semiconductor package at the second row 512 and the fourth column 524. The tracking file may include information on all semiconductor packages within segment 500.

As one of various examples, the semiconductor package at the second row 512 and third column 523 may include machine-readable physical identifier 540. Machine-readable physical identifier 540 may be encoded with one or more data elements related to the manufacturing of the semiconductor product, including but not limited to manufacturing year, manufacturing week, manufacturing day, manufacturing location, manufacturing lot, tape-and-reel strip, tape-and-reel row location and tape-and-reel column location. Machine-readable physical identifier 540 may be encoded using an error-correcting code, including but not limited to ECC-200.

A tracking file may record machine-readable physical identifier 540 and may associate machine-readable physical identifier 540 with the semiconductor package at the second row 512 and the third column 523. The tracking file may include information on all semiconductor packages within segment 500.

A machine-readable physical identifier may also be placed on the reel itself, on a packing tube or any other item used in the manufacturing, testing and shipping of a product.

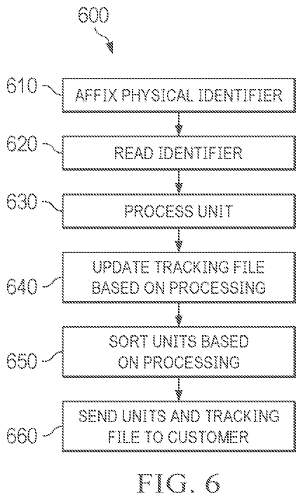

FIG. 6 illustrates a method of attaching a machine-readable physical identifier and of tracking information.

At operation 610, a machine-readable physical identifier may be affixed to a manufactured product. The machine-readable physical identifier may be printed on the manufactured product, etched in the manufactured product, attached to the manufactured product using an adhesive, or affixed in another manner not specifically mentioned. The manufactured product may be referred to as a unit. The machine-readable physical identifier may be encoded with one or more data elements related to the manufacturing of the manufactured product, including but not limited to manufacturing year, manufacturing week, manufacturing day, manufacturing location, manufacturing lot, and location within a package containing multiple manufactured products. The machine-readable physical identifier may be recorded in a tracking file.

At operation 620, the machine-readable physical identifier may be read as part of a manufacturing, testing, or supply chain operation. The machine-readable physical identifier may be read by an optical scanner or by another method.

At operation 630, the unit may be processed as part of a manufacturing, testing or supply chain operation. As one of various examples, the unit may be tested. As another example, the unit may be shipped from one facility to another.

At operation 640, a tracking file may be updated based on the processing in operation 630. As one of various examples, the tracking file may be updated with testing results of the unit. As another example, the tracking file may be updated with shipping information for the unit.

At operation 650, units may be sorted based on the results of the processing in operation 630. As one of various examples, units which fail the testing in operation 630 may be moved to a waste bin, while units which pass the testing in operation 630 may be moved to a subsequent step in the supply chain operation. The tracking file may be updated based on the sorting operation.

At operation 660, the units and the tracking file may be shipped to a customer.

In this manner, the tracking file may include manufacturing, testing, shipping and delivery information for respective manufactured products. The tracking file may be used by customers to track products to end customer locations and may be used by the manufacturer to trace any manufacturing issues. As one of various examples, the tracking file may record information which may be used to identify a testing issue on a specific day or in a specific testing location.

Examples of semiconductor products are not intended to be limiting. Other types of manufactured products may include a machine-readable physical identifier.

We claim:

1. A system comprising:
a manufactured product comprising a machine-readable physical identifier, the machine-readable physical identifier to encode one or more data elements related to the manufactured product; and
a tracking file wherein the one or more data elements are matched to the manufactured product, the tracking file to be updated based on one or more supply chain operations.

2. The system as claimed in claim 1, the machine-readable physical identifier to encode one or more numerical values and one or more alphanumeric values.

3. The system as claimed in claim 1, the machine-readable physical identifier comprising a Data Matrix code.

4. The system as claimed in claim 1, the machine-readable physical identifier comprising a Quick Response (QR) code.

5. The system as claimed in claim 1, the machine-readable physical identifier to be encoded using an error-correcting code.

6. The system as claimed in claim 1, the one or more supply chain operations comprising one or more of a manufacturing, shipping, or testing operation.

7. The system as claimed in claim 1, the machine-readable physical identifier to encode manufacturing date and lot number information of the manufactured product.

8. The system as claimed in claim 1, the tracking file to be updated with testing results of the manufactured product.

9. The system as claimed in claim 1, the tracking file to be updated with shipping dates and locations of the manufactured product.

10. The system as claimed in claim 1, the manufactured product comprising a semiconductor device in an encapsulated package, and the machine-readable physical identifier comprising a Data Matrix code printed on the encapsulated package.

11. The system as claimed in claim 10, the machine-readable physical identifier to encode a row location and a column location of a manufactured product in a tape-and-reel package.

12. The system as claimed in claim 10, the tracking file comprising results of a pass/fail testing operation performed on the manufactured product by an automated test program.

13. The system as claimed in claim 10, the tracking file comprising numerical results of a parametric testing operation performed on the manufactured product by an automated test program.

14. A method comprising:
affixing a machine-readable physical identifier to a manufactured product;
reading the physical identifier;
processing the manufactured product as part of a manufacturing, testing or supply chain operation;
updating a tracking file based on the results of the manufacturing, testing or supply chain operation;
sorting the manufactured product based on the results of the manufacturing, testing or supply chain operation; and
sending the manufactured product and the tracking file to a customer.

15. The method as claimed in claim 14, the machine-readable physical identifier to encode one or more numerical values and one or more alphanumeric values.

16. The method as claimed in claim 14, the machine-readable physical identifier comprising a Data Matrix code.

17. The method as claimed in claim 14, the machine-readable physical identifier comprising a Quick Response (QR) code.

18. The method as claimed in claim 14, the testing operation comprising an automated semiconductor test program.

19. The method as claimed in claim 14, the supply chain operation comprising shipping the manufactured product from a first location to a second location.

20. The method as claimed in claim 14, the updating a tracking file comprising recording pass/fail results of the testing operation, the results associated with a respective individual unit of a manufactured product.

21. The method as claimed in claim 14, the updating a tracking file comprising recording parametric results of a testing operation, the results associated with a respective individual unit of a manufactured product.

22. The method as claimed in claim 14, comprising sending the manufactured product and the tracking file to a customer.
